(19) United States
(12) Patent Application Publication
(10) Pub. No.: US 2013/0300974 A1
(43) Pub. Date: Nov. 14, 2013

(54) LIQUID CRYSTAL DISPLAY DEVICE AND MANUFACTURING METHOD THEREOF

(71) Applicant: JAPAN DISPLAY EAST INC., Mobara-shi (JP)

(72) Inventor: Takashi YOSHIMOTO, Mobara-shi (JP)

(73) Assignee: JAPAN DISPLAY EAST INC., Mobara-shi (JP)

(21) Appl. No.: 13/826,766

(22) Filed: Mar. 14, 2013

(30) Foreign Application Priority Data
May 9, 2012 (JP) 2012-107692

(51) Int. Cl. G02F 1/1333

(52) U.S. Cl. CPC G02F 1/133308
USPC 349/58; 445/24

(57) ABSTRACT

The present invention relates to a liquid crystal display device in which an upper frame covers the periphery of a liquid crystal display panel, and a front window is provided on the liquid crystal display panel and the upper frame. A cutout is formed in the corner portion of the upper frame, allowing the liquid crystal display panel to be exposed in the corner portion thereof. Thus, in a corner portion in which the cutout is formed in the upper frame, a side surface of the liquid crystal display panel and a side surface of the front window are directly matched for accurate positioning of the display area of the liquid crystal display panel.

### CLAIM OF PRIORITY

The present application claims priority from Japanese Patent Application NO. 2012-107692 filed on May 9, 2012, the content of which is hereby incorporated by reference into this application.

### BACKGROUND OF THE INVENTION

1. Field of the Invention

The present invention relates to a liquid crystal display device. More particularly, the present invention relates to a liquid crystal display device having a set configuration in which an upper frame and a front window are provided on a liquid crystal display panel, allowing accurate positioning of the center of the display area of the set of the liquid crystal display device, and the center of the liquid crystal display panel.

2. Description of the Related Art

In a liquid crystal display device, a TFT substrate includes pixel electrodes, thin film transistors (TFTs), and the like, which are arranged in a matrix array. A counter substrate is located opposite the TFT substrate, having color filters, and the like, which are formed at locations corresponding to the pixel electrodes of the TFT substrate, with a liquid crystal layer interposed between the TFT substrate and the counter substrate. In this configuration, an image is formed by controlling the transmittance of light of the liquid crystal molecules for each pixel.

With respect to a liquid crystal display device, there has been a strong demand for the reduction of a thickness of a liquid crystal display panel along with a demand for the reduction of a profile size of a set while maintaining a screen at a fixed size. To decrease the thickness of the liquid crystal display panel, after manufacturing the liquid crystal display panel, an outer side of the liquid crystal display panel is polished to decrease the thickness of the liquid crystal display panel.

The liquid crystal display device is constituted of a TFT substrate which forms pixel electrodes, TFTs and the like thereon, and a counter substrate which forms color filters thereon. A glass substrate which is served for forming the TFT substrate and the counter substrate has a thickness thereof standardized to 0.5 mm or to 0.7 mm. It is difficult to acquire a glass substrate other than the standardized glass substrate from a market. Further, an extremely thin glass substrate gives rise to drawbacks on mechanical strength, deflection or the like in manufacturing steps thereof thus lowering a manufacturing yield rate. Accordingly, after forming the liquid crystal display panel using the standardized glass substrate, an outer surface of the liquid crystal display panel is polished to decrease the thickness of the liquid crystal display panel.

The reduction of the thickness of the liquid crystal display panel gives rise to a drawback on mechanical strength. That is, there exists a possibility that the liquid crystal display panel is broken when mechanical pressure is applied to a display screen of the liquid crystal display panel. In order to prevent this, a front window formed of glass, and the like, is adhered to the front surface of the liquid crystal display panel by an adhesive. An example of such a liquid crystal display device is described in Japanese Unexamined Patent Publication No. 2009-8973.

### SUMMARY OF THE INVENTION

The liquid crystal display panel does not emit light by itself, and it is necessary to have a backlight. It is difficult to focus the light from the backlight only on the display area, so that the light emitted around the display area is blocked by various ways. However, it is difficult to completely block such a stray light. In the liquid crystal display device using a front window, there is a problem of the stray light from the backlight or other components, which is incident from the side surface of the front window.

FIG. 2 is a cross-sectional view of the vicinity of the display part of a liquid crystal display device using a front window 10. In FIG. 2, the periphery of a liquid crystal display panel 2 is covered by an upper frame 30 which is formed of a metal. The upper frame 30 has the role of blocking the light from a backlight 3. The configuration of FIG. 2 will be described in detail below.

In FIG. 2, the center of the display area that is defined by a case 20, and the center of the display area of the liquid crystal display panel 2 are positioned by fitting the end portion of the front window 10 and the inner end portion of the case 20 together. For this reason, if the center of the display area of the liquid crystal display panel 2 and the center of the front window 10 are not properly adjusted, the center of the display area of the liquid crystal display panel 2 and the center of the display area that is defined by the case 20 are displaced. When the distance between the center of the display area of the case 20, and the center of the display area of the liquid crystal display panel 2 is not within a predetermined range, it is determined to be defect.

FIG. 13 is an exploded perspective view showing the parts provided on the upper side of the liquid crystal display panel 2 in a conventional configuration. In FIG. 13, the liquid crystal display panel 2 is located on the bottom. In the liquid crystal display panel 2, a counter substrate 200 is located opposite a TFT substrate 100 in which TFTs and pixel electrodes are arranged in a matrix array, with a liquid crystal layer, not shown, interposed between the TFT substrate 100 and the counter substrate 200. The liquid crystal layer is sealed by a sealing member not shown. The TFT substrate 100 of the liquid crystal display panel 2 is provided with an IC driver 70 to which a flexible wiring substrate 80 is connected. In FIG. 12, an upper polarizer 210 is provided on the counter substrate 200.

An upper frame 30 is provided on the liquid crystal display panel 2 to block light around the liquid crystal display panel 2. The upper frame 30 aims to block light, so that the thickness of the upper frame 30 can be as small as about 0.15 mm. The material of the upper frame 30 is, for example, steel use stainless (SUS). The upper frame 30 is provided so as to cover the periphery of the liquid crystal display panel 2. The upper frame 30 and the front window 10 are adhered together by an adhesive 50 (hereinafter referred to as UV adhesive) which is cured by irradiation with ultraviolet light.

In FIG. 13, the UV adhesive 50 is applied to the upper polarizer of the liquid crystal display panel 2, and also applied to the upper side of the upper frame 30. The UV adhesive 50 shown in FIG. 13 has a sheet-like shape, but actually the UV adhesive 50 is a liquid adhesive that is applied by printing or other method. In FIG. 13, the front window 10 is adhered on the liquid crystal display panel 2 and the upper frame 30. A black light block print 12 is provided around the front window 10.

FIG. 14 is a schematic diagram of a positioning jig 500 used for adhering the front window 10 to the upper frame 30, and the like, according to the conventional example. In FIG. 14, the positioning of the front window 10 is done based on the upper frame 30. This is because the profile of the upper frame 30 is the largest and it is natural to determine the position of the front window 10 based on the upper frame 30.

However, while this configuration allows the center of the upper frame 30 and the center of the front window 10 to be matched, there is a displacement between the center of the display area of the liquid crystal display panel 2, and the center of the upper frame 30 or the center of the front window 10 at a predetermined distance. Thus, as shown in FIG. 1, the completed liquid crystal display device is mounted in the case 20, such as a digital still camera (DSC), by positioning it with respect to the end portion of the front window 10. However, at this time, the center of the display area of the liquid crystal display panel 2, and the center of the display area that is defined by the case 20 include an error in the distance between the upper frame 30 and the liquid crystal display panel 2 or the front window 10. Thus, there is a problem that it is difficult to achieve an accurate positioning.

FIG. 15 is a perspective view showing the state in which the upper frame 30, the front window 10, and the like, are adhered by using the jig 500 as shown in FIG. 14. FIG. 15 does not show the liquid crystal display panel 2 that is provided within the upper frame 30. In FIG. 15, the front window 10 is adhered on the upper frame 30. The front window 10 shown in FIG. 15 is smaller than the upper frame 30, but on the contrary, the upper frame 30 may be smaller than the front window 10. However, the problem is the same as described above.

In the configuration in which the liquid crystal display device in which the upper frame 30 covers the periphery of the liquid crystal display panel 2 and the front window 10 is adhered on the liquid crystal display panel 2 and the upper frame 30, is mounted within the case 20 such as DSC1, it is desirable to reduce the displacement between the center of the display area that is defined by the case 20 such as the DSC1, and the center of the display area of the liquid crystal display panel 2.

The present invention overcomes the above problem.

Although the present invention can be understood from various points of view, the following is a typical liquid crystal display device and manufacturing method thereof according to the present invention from one aspect. Further, a liquid crystal display device and manufacturing method thereof according to the present invention from another aspect will be apparent from the following description of an embodiment of the present invention, or other information.

A summary of a typical one of the inventions disclosed in this application will be briefly described as follows.

(1) A liquid crystal display device comprising:

a liquid crystal display panel including a first substrate in which TFTs and pixel electrodes are arranged in a matrix array, a second substrate which faces the first substrate, and a liquid crystal layer which is interposed between the first substrate and the second substrate, and an upper polarizer which is adhered to the second substrate;

an upper frame covering a periphery of the liquid crystal display panel; and

a third substrate being adhered on the upper frame and the upper polarizer by an adhesive,

wherein the liquid crystal display panel has a side surface, the side surface consisting of at least one of the first and second substrates,

the upper frame has at least one cutout, and a portion of the side surface is exposed by the cut out of the upper frame.

(2) The liquid crystal display device described in (1), wherein the cutout of the upper frame is formed in a corner portion.

(3) The liquid crystal display device described in (1), wherein the cutout of the upper frame is formed on a short side of the upper frame.

(4) The liquid crystal display device described in (1), wherein the cutout of the upper frame is formed on a long side of the upper frame.

(5) The liquid crystal display device described in (1), wherein the portion of the side surface is not covered by the upper frame.

(6) The liquid crystal display device described in (1), wherein the liquid crystal display panel has a main surface which intersects the side surface, and the third substrate covers the main surface.

(7) The liquid crystal display device described in (1), wherein the liquid crystal display device is mounted to a case of a display device with reference to an end portion of the front window.

(8) A manufacturing method of a liquid crystal display device,

wherein the liquid crystal display device includes:

a liquid crystal display panel including a first substrate in which TFTs and pixel electrodes are arranged in a matrix array, a second substrate which faces the first substrate, a liquid crystal layer which is interposed between the first substrate and the second substrate, and an upper polarizer which is adhered to the second substrate,

an upper frame covering a periphery of the liquid crystal display panel; and

a third substrate being adhered on the upper frame and the upper polarizer by an adhesive,

wherein the liquid crystal display panel has a side surface, the side surface consisting of at least one of the first and second substrates, and

the upper frame has at least one cutout, and a portion of the side surface is exposed by the cut out of the upper frame,

the manufacturing method comprising the steps of:

applying a UV adhesive to the liquid crystal display panel or the third substrate;

positioning the liquid crystal display panel and the third substrate, with reference to the side surface of the liquid crystal display panel and to a side surface of the third substrate, in the cutout portion of the upper frame; and

adhering the third substrate to the liquid crystal display panel and the upper frame by irradiating the UV adhesive with ultraviolet light.

(9) The manufacturing method of a liquid crystal display device described in (8), wherein the cutout of the upper frame is formed in a corner portion.

(10) The manufacturing method of a liquid crystal display device described in (8), wherein the cutout of the upper frame is formed on a short side of the upper frame.

(11) The manufacturing method of a liquid crystal display device described in (8), wherein the cutout of the upper frame is formed on a long side of the upper frame.

(12) The liquid crystal display device described in (8), wherein the portion of the side surface is not covered by the upper frame.

(13) The manufacturing method of a liquid crystal display device according to (8), wherein the liquid crystal display panel has a main surface which intersects the side surface of the liquid crystal display panel, and the third substrate covers the main surface.

According to the present invention, it is possible to accurately match the center of the display area based on the front window, and the center of the display area of the liquid crystal display panel. Thus, when the liquid crystal display device is mounted to the case of the display device based on the front window, it is possible to easily and accurately match the center of the display area of the display device that is defined by the case, and the center of the display area of the liquid crystal display device.

### BRIEF DESCRIPTION OF THE DRAWINGS

FIG. 1 is a plan view showing an example of a display device in which a liquid crystal display device according to the present invention is mounted;

FIG. 2 is a cross-sectional view taken along line A-A of FIG. 1;

FIG. 3 is a perspective view of the parts of a liquid crystal display device according to an embodiment of the present invention;

FIG. 4 is a perspective view of an upper frame of the liquid crystal display device according to the embodiment of the present invention;

FIG. 5 is a perspective view of an assembly of the liquid crystal display panel, the upper frame, and the front window in the liquid crystal display device according to the embodiment of the present invention;

FIG. 6 is a cross-sectional view taken along line B-B of FIG. 5;

FIG. 7 is a cross-sectional view showing the state in which the upper frame is set in an upper frame setting jig;

FIG. 8 is a cross-sectional view showing the state in which the upper frame and the liquid crystal display panel are set in the liquid crystal display panel-upper frame setting jig;

FIG. 9 is a cross-sectional view showing the state in which the liquid crystal display panel, the upper frame, and the front window are set in a front window setting jig;

FIG. 10 is a cross-sectional view showing the state in which the front window and the liquid crystal display panel are positioned by a corner setting jig;

FIG. 11 is a cross-sectional view showing the state in which the front window and the liquid crystal display panel are positioned by another corner portion setting jig;

FIGS. 12A and 12B are comparative tables of the setting error according to a conventional example and the present invention;

FIG. 13 is a perspective view of the parts of a liquid crystal display device according to the conventional example;

FIG. 14 is a view of a positioning jig of the upper frame and the front window in the liquid crystal display device according to the conventional example; and

FIG. 15 is a perspective view of an assembly of the liquid crystal display panel, the upper frame, and the front window of the liquid crystal display device according to the conventional example.

### DETAILED DESCRIPTION OF THE INVENTION

Hereinafter, the content of the present invention will be described in detail with reference to an embodiment.

It is to be noted that components having the same function are denoted by the same reference numerals throughout the drawings for describing the embodiment, and the repetitive description thereof is omitted. The following embodiment is not intended to limit interpretation of the scope of the claims.

### Embodiment

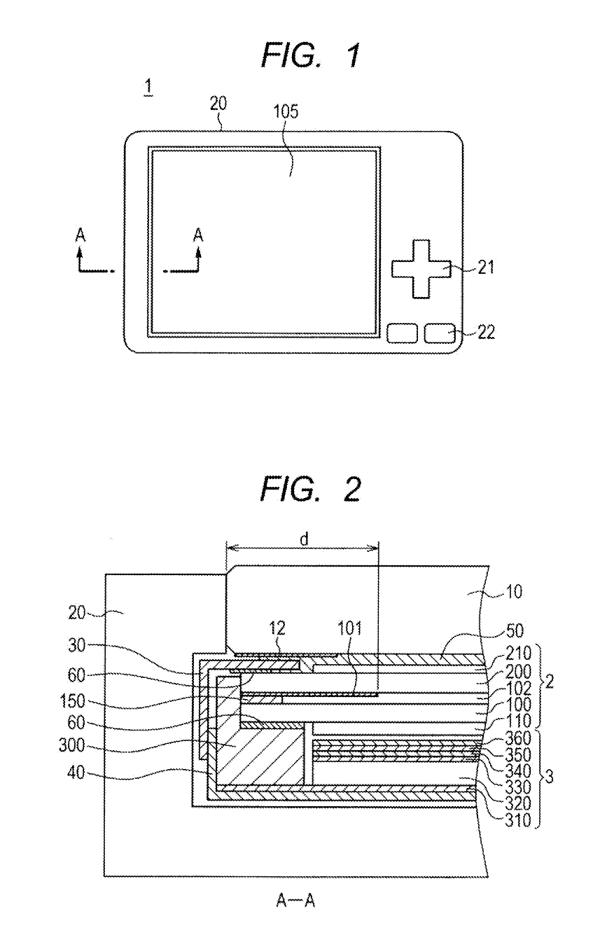

FIG. 1 is a plan view of a digital still camera (DSC) 1 as an example to which the present invention is applied. It goes without saying that in addition to the DSC, the present invention can also be applied to other devices having a display. In FIG. 1, a control button 21, a switch button 22 and the like are provided on the right side of a display area 105. The DSC 1 is required to provide a high image quality, so that the number of pixels increases. If the center of the display area that is defined by a case 20 is displaced from the center of the display of the liquid crystal display panel, there is a difficulty in viewing the screen. Thus, it is necessary to set the center of the display area that is defined by the case 20, and the center of the display of the liquid crystal display panel within a predetermined range.

FIG. 2 is a cross-sectional view taken along line A-A of FIG. 1. In FIG. 2, a liquid crystal display panel 2 has the following configuration. That is, the liquid crystal display panel 2 includes a TFT substrate 100 (first substrate) in which TFTs and pixel electrodes are arranged in a matrix array, and a counter substrate 200 (second substrate) in which color filters and the like are formed. Then, a liquid crystal layer 102 is interposed between the TFT substrate 100 and the counter substrate 200. A lower polarizer 110 is adhered to the lower side of the TFT substrate 100. Further, an upper polarizer 210 is adhered to the upper side of the counter substrate 200. The liquid crystal layer is sealed by a sealing member 150. A black matrix 101 is formed around the counter substrate 200. A display area 105 of the liquid crystal display panel 2 is defined by the black matrix 101. The liquid crystal display panel 2 is placed on a mold 300 through an adhesive such as a double-sided adhesive tape 60.

The back side of the liquid crystal display panel 2 is provided with a backlight 3. In FIG. 2, the backlight 3 is formed by a reflective sheet 310, a light guide plate 320, a lower diffusion sheet 330, a lower prism sheet 340, an upper prism sheet 350, an upper diffusion sheet 360, and a light source such as LED, not shown, from the bottom. The backlight 3 is placed within the mold 300. The backlight 3 including the mold 300 is covered by a lower frame 40.

The front window 10 (third substrate) is adhered on the liquid crystal display panel 2 by the UV adhesive 50. Further, the upper frame 30 is adhered on the counter substrate 200 of the liquid crystal display panel 2 by the double-sided adhesive tape 60.

In FIG. 2, it is necessary to match the center of the display area that is defined by the case 20, and the center of the display area of the liquid crystal display panel 2. The center of the display area of the liquid crystal display panel 2 is defined by the black matrix 101 that is formed in the periphery of the liquid crystal display panel 2. Further, the end portion of the front window 10 is fitted to the inner end portion of the case 20, so that it is necessary to define the distance d from the end portion of the front window 10 to the inner end portion of the black matrix 101 of the liquid crystal display panel 2 within a predetermined range.

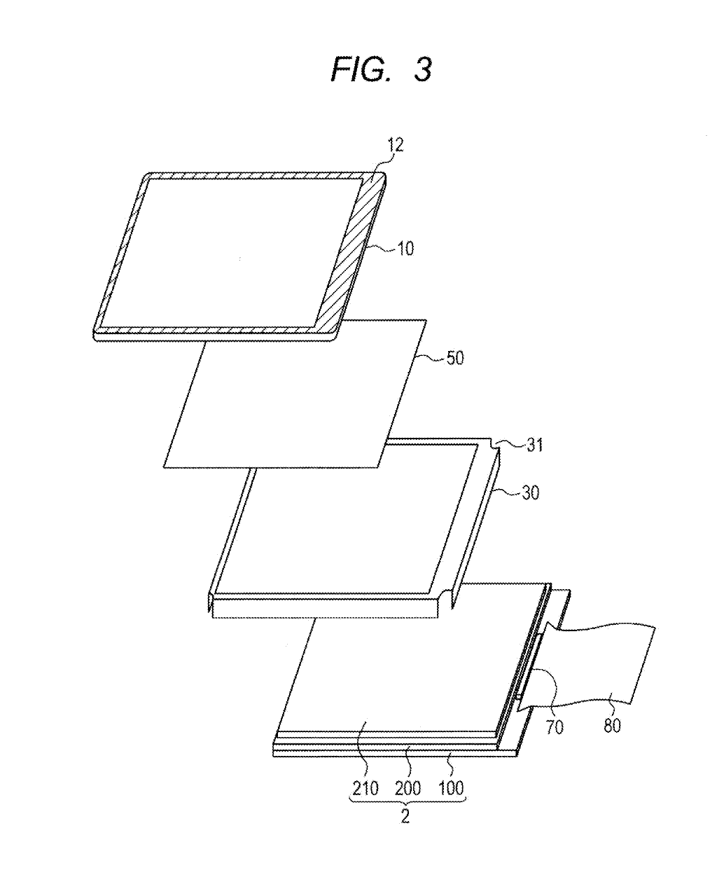

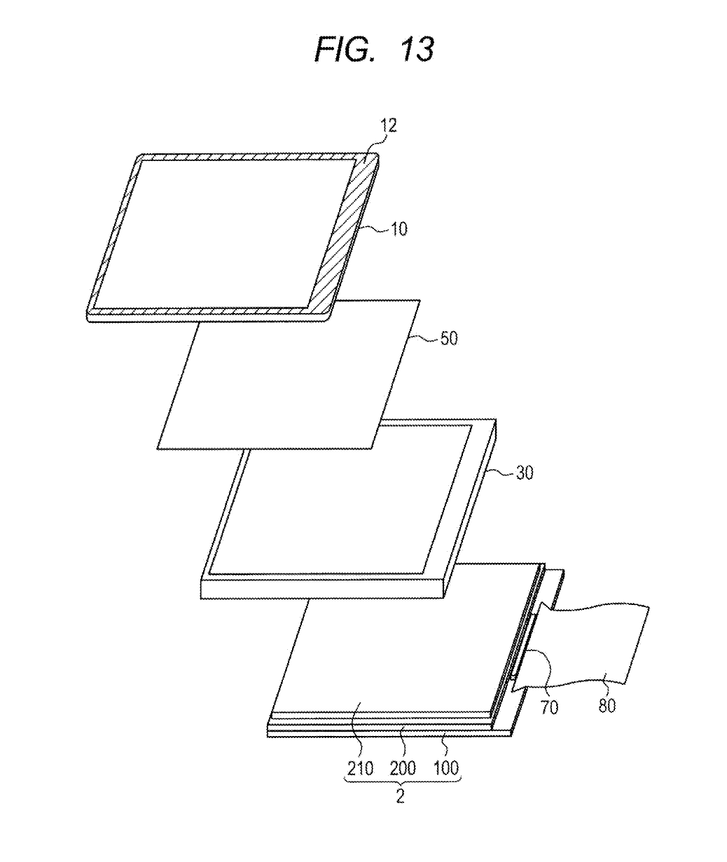

FIG. 3 is an exploded perspective view of the liquid crystal display panel 2, the upper frame 30, the UV adhesive 50, and the front window 10 in the liquid crystal display device according to the present invention. The perspective view of FIG. 3 is the same as that described in FIG. 13, except the upper frame 30. Further, it is shown that the UV adhesive 50 has a sheet-like form, but actually it is formed by printing, or other methods, on the liquid crystal display panel 2 and the upper frame 30, or the front window 10. The front window 10 is first positioned and placed in the liquid crystal display panel 2 and the upper frame 30. Then, the UV adhesive 50 is cured by irradiation with ultraviolet light. In this way, the front window 10 is adhered to the liquid crystal display panel 2, and the like, by the cured UV adhesive 50.

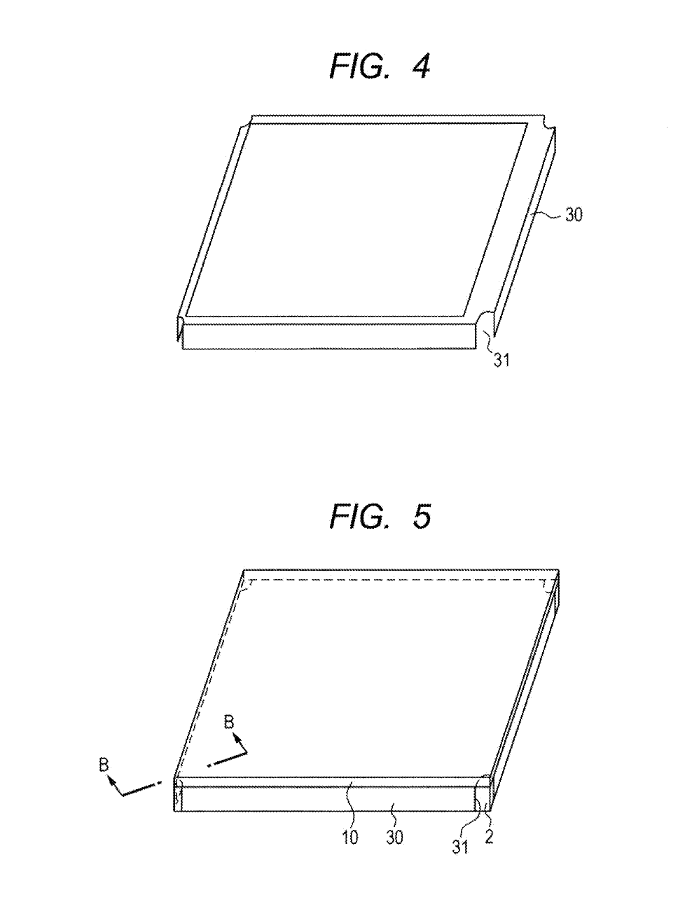

In FIG. 3, a cutout 31 is formed in a corner portion of the upper frame 30, which is the feature of the present invention. FIG. 4 is a perspective view showing only the upper frame 30. By using the upper frame 30 shown in FIG. 4, the liquid crystal display panel 2 is exposed in the cutout 31 in the corner portion of the upper frame 30 after the liquid crystal display panel 2 and the upper frame 30 are assembled.

FIG. 5 is a perspective view of this state. In FIG. 5, the liquid crystal display panel 2 is covered by the upper frame 30. However, the liquid crystal display panel 2 is exposed in the corner portion. The front window 10 is adhered so as to cover the liquid crystal display panel 2 and the upper frame 30. In FIG. 5, it is shown that the outside dimensions of the liquid crystal display panel 2 and the front window 10 are equal to each other. However, this is just an example and the profile of the liquid crystal display panel 2 or the front window 10 is arbitrary.

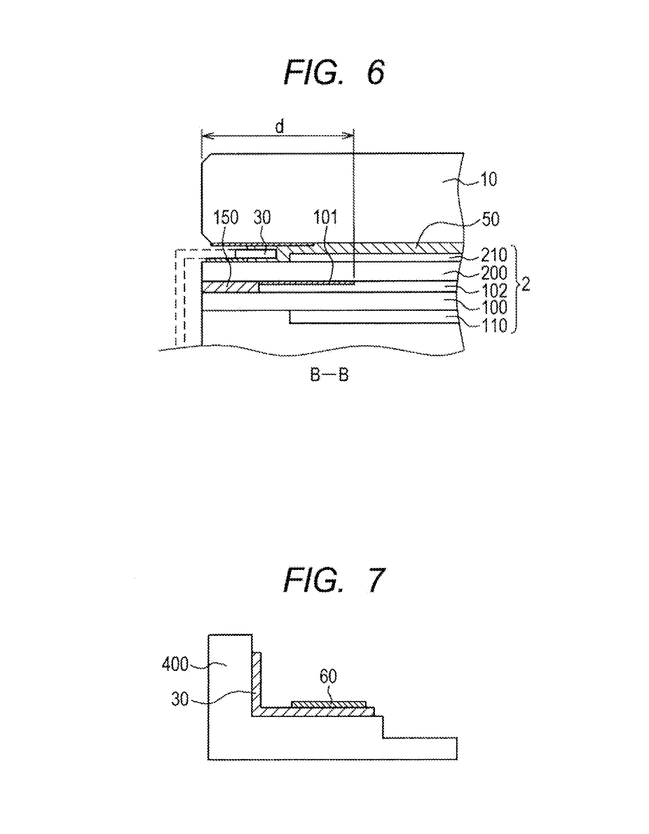

FIG. 6 is a cross-sectional view taken along line B-B of FIG. 5. In FIG. 6, the upper frame 30 is adhered on the liquid crystal display panel 2 by the double-sided adhesive tape 60. The cutout 31 is formed in the corner portion of the upper frame 30. The dashed line shows the position of the upper frame 30 when the cutout 31 might not be present. In FIG. 6, the front window 10 is adhered on the liquid crystal display panel 2 and the upper frame 30 by the UV adhesive 50. In FIG. 6, the end portion (side surface) of the front window 10, and the end portion (side surface) of the liquid crystal display panel 2 are accurately matched by a jig according to the assembly method described below. In this way, it is possible to accurately match the center of the display area of the case 20 that is defined by the end portion of the front window 10, and the display area of the liquid crystal display panel 2 that is defined by the black matrix 101 of the liquid crystal display panel 2, within a predetermined range.

FIGS. 7 to 10 are schematic diagrams of the assembly method of the liquid crystal panel 2, the upper frame 30, and the front window 10 according to the present invention. FIG. 7 is a cross-sectional view showing the state in which the adhesive such as the double-sided adhesive tape 60 is adhered to the inside of the upper frame 30 which is then set to the upper frame setting jig 400. FIG. 7 is a cross-sectional view of the upper frame 30 except the corner portion thereof.

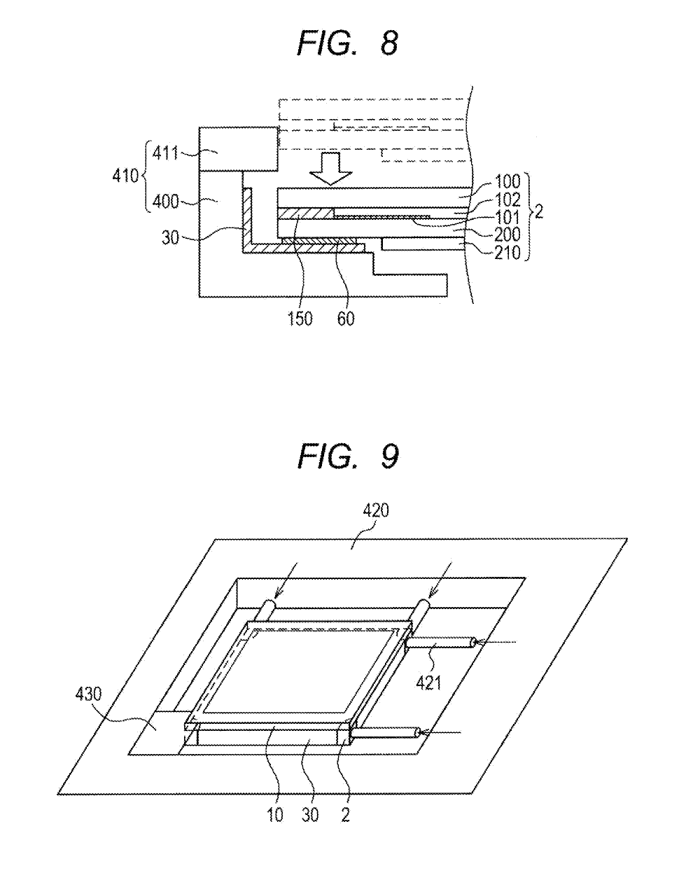

FIG. 8 is a schematic cross-sectional view showing the state in which the liquid crystal display panel 2 is set on the inside of the upper frame 30. In FIG. 8, a liquid crystal display panel-upper frame setting jig 410 is a device in which a guide 411 for positioning the liquid crystal display panel 2 is added to the upper frame setting jig 400. The liquid crystal display panel 2 is adhered to the inside of the upper frame 30 along the guide 411 via the adhesive tape 60. In this way, the assembly of the upper frame 30 and the liquid crystal display panel 2 is formed. Note that the dashed line in FIG. 8 shows the process in which the liquid crystal display panel 2 is falling to the inside of the upper frame 30 along the guide 411.

FIG. 9 is a perspective view of a front window setting jig 420 for adhering the front window 10 to the assembly of the upper frame 30 and the liquid crystal display panel 2. The front window setting jig 420 has a tray-like shape with a concave portion on the inside. In FIG. 9, the assembly of the liquid crystal display panel 2 and the upper frame 30 is placed in the concave portion of the tray. Then, the UV adhesive 50 is provided on the assembly and then the front window 10 is provided on the UV adhesive 50. The UV adhesive 50 is not cured yet, so that it is possible to determine the position of the assembly by moving the front window 10.

In FIG. 9, the corner portion of the liquid crystal display panel 2 and the corner portion of the front window 10 are positioned by pressing against a corner setting jig 430 that is provided in the concave portion of the tray. At this time, the pressing is done by a pressing jig 421, which is schematically shown as a round bar in FIG. 9. Here, the pressing jig 421 is provided at four locations. However, the pressing jig 421 is not necessarily provided at all of the four locations. For example, the pressing jig 421 may be provided at two corners. It is possible to select the location and the number or other characteristics of the pressing jig 421, appropriately, depending on the size of the liquid crystal display panel 2, and the like. In FIG. 9, the important point is that the upper frame 30 does not come into contact with the corner setting jig 430, and that the corner portion of the liquid crystal display panel 2 as well as the corner portion of the front window 10 contact the corner setting jig 430.

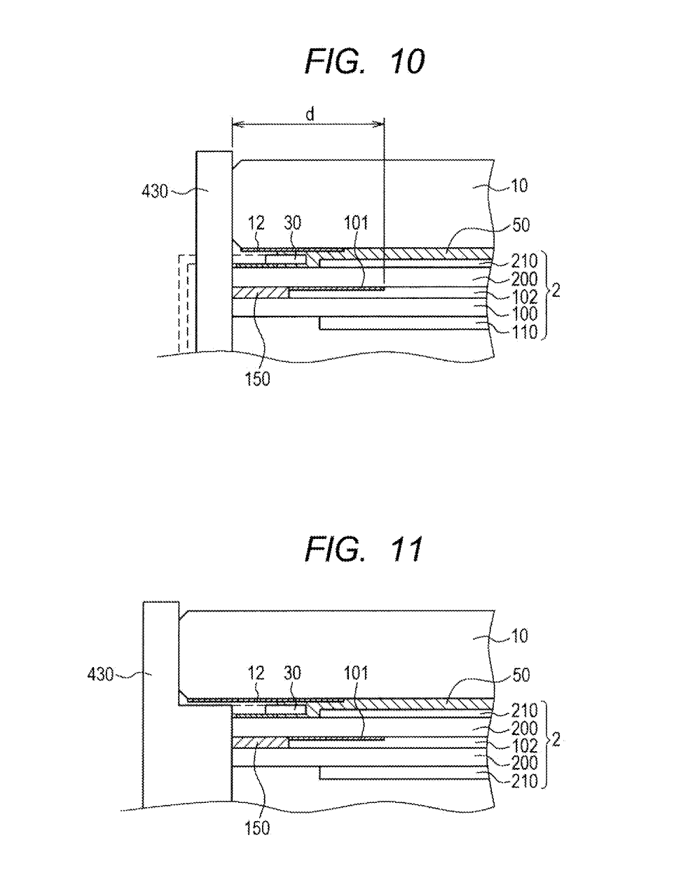

FIG. 10 is a schematic cross-sectional view of this state. In FIG. 10, the corner setting jig 430 directly contacts the end portion of the front window 10 as well as the end portion of the liquid crystal display panel 2. FIG. 10 shows the corner portion in which the cutout 31 is present in the upper frame 30, so that the upper frame 30 does not contact the corner setting jig 430. This makes it possible to directly position the end portion of the liquid crystal display panel 2 and the end portion of the front window 10.

Thus, it is possible to ignore the error between the liquid crystal display panel 2 and the upper frame 30, and the upper frame 30 and the front window 10. As a result, it is possible to set the distance d between the end portion of the front window 10, and the end portion of the black matrix 101 of the liquid crystal display panel 2 more accurately than the conventional example. In other words, it is possible to reduce the error in the distance between the center of the display area of the case 20 that is defined by the end portion of the front window 10, and the center of the display area that is defined by the end portion of the black matrix 101 around the liquid crystal display panel 2.

FIG. 10 shows an example when the profile of the liquid crystal display panel 2 is equal to the profile of the front window 10 while FIG. 11 is a cross-sectional view of the corner setting jig 430 when the profile of the front window 10 is larger than the profile of the liquid crystal display panel 2. As shown in FIG. 11, when the profile of the liquid crystal display panel 2 and the profile of the front window 10 are different, it is possible to easily adjust the difference by providing a step in the corner setting jig 430.

The assembly of the liquid crystal display panel 2, the upper frame 30, and the front window 10 is formed as described above. Then, the backlight 3 placed in the mold 300 is provided on the back side of the liquid crystal display panel 2. In this way, the liquid crystal display device shown in FIG. 2 is formed. The liquid crystal display panel 2 and the mold 300, in which the backlight 3 is placed, are adhered together by the adhesive such as the double-sided adhesive tape 60.

When the liquid crystal display device formed as described above is installed into the case 20 such as the DSC 1, the end portion of the case 20 and the end portion of the front window 10 are fitted to match the display area defined by the case 20 and the display area of the liquid crystal display panel 2. According to the present invention, it is possible to correctly set the distance d from the end portion of the front window 10 to the end portion of the black matrix 101 around the liquid crystal display panel 2. Thus, it is possible to accurately match the center of the display area that is defined by the case 20, and the center of the display area of the liquid crystal display panel 2.

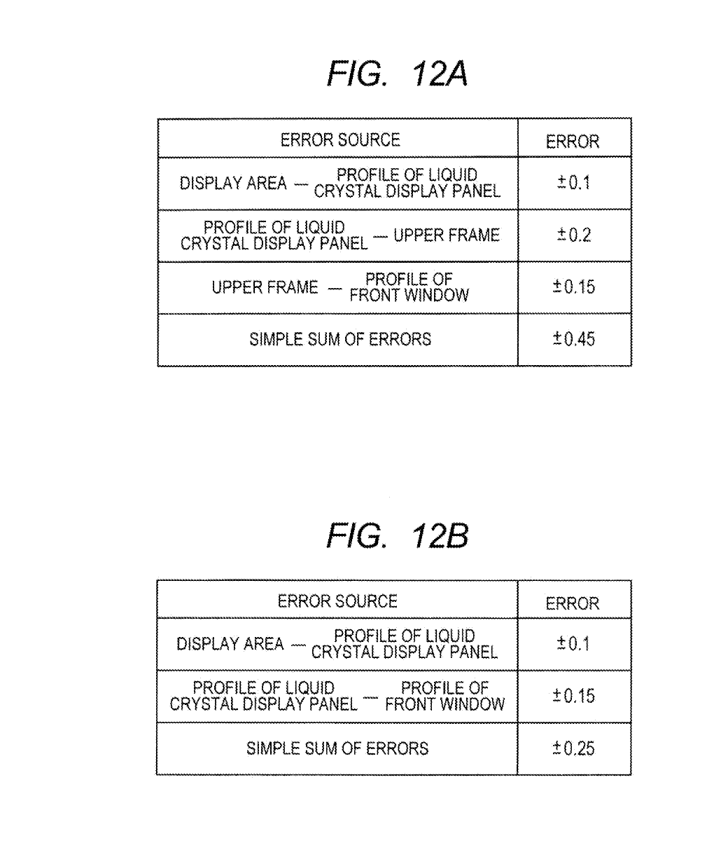

FIGS. 12A and 12B are tables that evaluate the displacement between the center of the display area of the liquid crystal display panel 2, and the center of the display area that is defined by the profile of the front window 10, according to the present invention and the conventional technology. FIG. 12A shows the case of a certain device. FIG. 12A is the table that evaluates the distance between the center of the display area that is defined by the inner end portion of the case 20, that is, the end portion of the front window 10 and the center of the display area of the liquid crystal display panel 2 in the conventional technology.

In FIG. 12A, the display area represents the display area of the liquid crystal display panel 2. The “display area-liquid crystal display panel profile” represents the error in the distance between the center defined by the profile of the liquid crystal display panel 2, and the center of the display area of the actual liquid crystal display panel 2. This error occurs due to an error or other reason when the liquid crystal display panel 2 is separated from the mother panel. The error is ±0.1 mm.

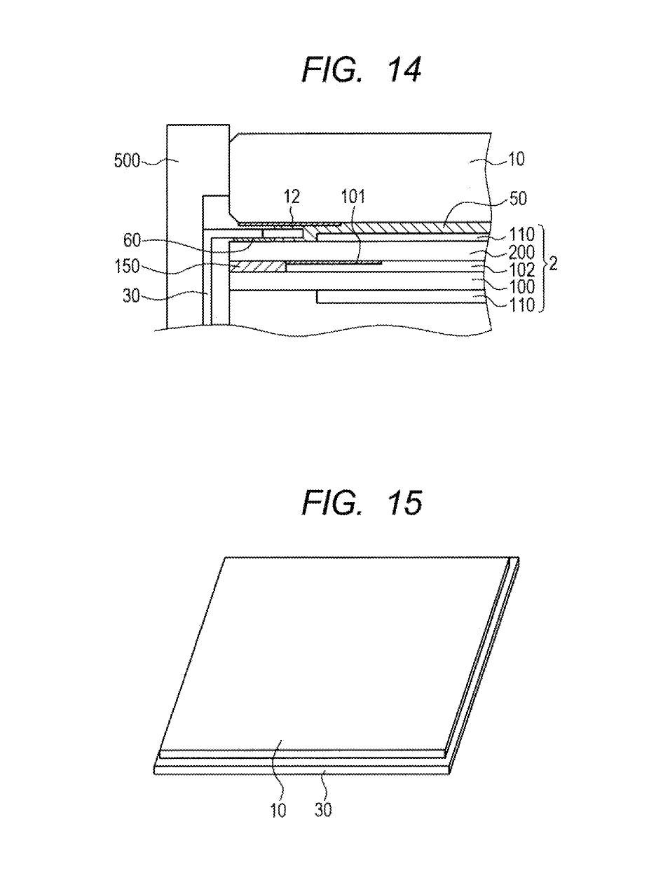

The “liquid crystal display panel profile-upper frame” represents the error that occurs when the liquid crystal display panel 2 is adhered to the inside of the upper frame 30 by the double-sided adhesive tape 60 as shown in FIG. 8. The error is ±0.2 mm. The “upper frame-front window profile” represents the error that occurs when the front window 10 is adhered to the liquid crystal display panel 2 with reference to the upper frame 30 as shown in FIG. 14. The error is ±0.15 mm. When the total error is evaluated as a simple addition of these errors, the error in the conventional example is ±0.45 mm.

FIG. 12B is a table that evaluates the distance between the center of the display area that is defined by the inner end portion of the case 20, namely, defined by the end portion of the front window 10, and the center of the display area of the liquid crystal display panel 2. In FIG. 12B, the “display area-liquid crystal display panel profile” is the same as that described in FIG. 12A. The error is ±0.1 mm.

According to the present invention, the position of the front window 10 is not defined by the upper frame 30, so that the error does not occur due to the “liquid crystal display panel profile-upper frame” and the “upper frame-front window profile”. On the other hand, according to the present invention, the liquid crystal display panel 2 and the front window 10 are directly positioned as shown in FIG. 10, so that an error occurs in the assembly process. The error is ±0.15 mm.

When the total error is evaluated as a simple addition of these errors, the error in the case of the present invention is ±0.25 mm. In other words, according to the present invention, the error in the distance between the center of the display area of the liquid crystal display panel 2, and the center of the display area that is defined by the inner end portion of the case 20, namely, defined by the end portion of the front window 10 is reduced by 0.2 mm compared to the conventional example. Considering that the product is determined to be defect if the error in the position of the center of the display area is large, the effect of improvement in the reduction from ±0.45 mm to ±0.25 mm is very large.

As described above, the cutout 31 of the upper frame 30 is formed in the corner portion. This allows the liquid crystal display panel 2 to be exposed in the corner portion when the liquid crystal display panel 2 and the front window 10 are positioned. This method has the advantage that the positioning is done in the corner portion in which the liquid crystal display panel 2 and the front window 10 can be positioned by only pressing the corner portion thereof by the pressing jig 421 as shown in FIG. 9.

However, the present invention is not limited to the method of using the cutout 31 that is formed in the corner portion of the upper frame 30. The positioning can also be done by the cutout formed on the short or long side of the upper frame 30. In other words, it is possible to reduce the displacement in the long side direction of the display area by forming the cutout on the short side of the upper frame 30. Similarly, it is possible to reduce the displacement in the short side direction of the display area by forming the cutout on the long side of the upper frame 30.

The above description exemplifies the liquid crystal display device used for the DSC 1 or other portable devices. However, the present invention is not limited to this example, and can also be applied to liquid crystal display devices for other applications as long as they have the following configuration. That is, the upper frame 30 is provided on the periphery of the liquid crystal display panel 2, and the front window 10 is provided on the liquid crystal display panel 2 and the upper frame 30.

The invention made by the present inventors has been specifically described with reference to the embodiment thereof. However, the present invention is not limited to the above embodiment and various modifications and changes may be made thereto without departing from the broader spirit and scope of the present disclosure, as set forth in the claims.

It is to be understood that the present invention is not limited to the exemplary embodiment and may include various modifications and alternative forms. For example, as noted previously, the forgoing description of the specific example is presented for illustration and description. It is not intended to be exhaustive or to limit the invention to the precise forms disclosed. Further, a part of the configuration of the embodiment can be replaced by a configuration of another embodiment, or a configuration of an embodiment can be added to a configuration of another embodiment. Further, addition, deletion, or replacement of other configurations is possible for a part of the configuration of the embodiment.

What is claimed is:

1. A liquid crystal display device comprising:
a liquid crystal display panel including a first substrate in which TFTs and pixel electrodes are arranged in a matrix array, a second substrate which faces the first substrate, and a liquid crystal layer which is interposed between the first substrate and the second substrate, and an upper polarizer which is adhered to the second substrate;
an upper frame covering a periphery of the liquid crystal display panel; and
a third substrate being adhered on the upper frame and the upper polarizer by an adhesive,
wherein the liquid crystal display panel has a side surface, the side surface consisting of at least one of the first and second substrates,
the upper frame has at least one cutout, and a portion of the side surface is exposed by the cut out of the upper frame.

2. The liquid crystal display device according to claim 1, wherein the cutout of the upper frame is formed in a corner portion.

3. The liquid crystal display device according claim 1, wherein the cutout of the upper frame is formed on a short side of the upper frame.

4. The liquid crystal display device according to claim 1, wherein the cutout of the upper frame is formed on a long side of the upper frame.

5. The liquid crystal display device according to claim 1, wherein the portion of the side surface is not covered by the upper frame.

6. The liquid crystal display device according to claim 1, wherein the liquid crystal display panel has a main surface which intersects the side surface, and the third substrate covers the main surface.

7. The liquid crystal display device according to claim 1, wherein the liquid crystal display device is mounted to a case of a display device with reference to an end portion of the front window.

8. A manufacturing method of a liquid crystal display device,
wherein the liquid crystal display device includes:
a liquid crystal display panel including a first substrate in which TFTs and pixel electrodes are arranged in a matrix array, a second substrate which faces the first substrate, a liquid crystal layer which is interposed between the first substrate and the second substrate, and an upper polarizer which is adhered to the second substrate,
an upper frame covering a periphery of the liquid crystal display panel; and
a third substrate being adhered on the upper frame and the upper polarizer by an adhesive,
wherein the liquid crystal display panel has side surface, the side surface consisting of at least one of the first and second substrates, and
the upper frame has at least one cutout, and a portion of the side surface is exposed by the cut out of the upper frame,
the manufacturing method comprising the steps of:
applying a UV adhesive to the liquid crystal display panel or the third substrate;
positioning the liquid crystal display panel and the third substrate, with reference to the side surface of the liquid crystal display panel and to a side surface of the third substrate, the cutout portion of the upper frame; and
adhering the third substrate to the liquid crystal display panel and the upper frame by irradiating the UV adhesive with ultraviolet light.

9. The manufacturing method of a liquid crystal display device according to claim 8, wherein the cutout of the upper frame is formed in a corner portion.

10. The manufacturing method of a liquid crystal display device according to claim 8, wherein the cutout of the upper frame is formed on a short side of the upper frame.

11. The manufacturing method of a liquid crystal display device according to claim 8, wherein the cutout of the upper frame is formed on a long side of the upper frame.

12. The liquid crystal display device according to claim 8, wherein the portion of the side surface is not covered by the upper frame.

13. The manufacturing method of a liquid crystal display device according to claim 8, wherein the liquid crystal display panel has a main surface which intersects the side surface of the liquid crystal display panel, and the third substrate covers the main surface.
